(19) United States
(12) Patent Application Publication
(10) Pub. No.: US 2016/0282598 A1
(43) Pub. Date: Sep. 29, 2016

(54) 3D Microscope Calibration

(71) Applicant: CANON KABUSHIKI KAISHA, Ohta-ku, Tokyo (JP)

(72) Inventors: JAMES AUSTIN BESLEY, Killara (AU); ANDREW DOCHERTY, St Leonards (AU)

(21) Appl. No.: 15/034,277

(22) PCT Filed: Nov. 6, 2014
(86) PCT No.: PCT/AU2014/001032

§ 371 Date: May 4, 2016

(30) Foreign Application Priority Data
Nov. 7, 2013 (AU) 2013254920

(51) Int. Cl. G02B 21/36; G02B 21/22

(52) U.S. Cl. CPC G02B 21/367; G02B 21/22

(57) ABSTRACT

A method calibrates a microscope using a test pattern by capturing a plurality of images of the test pattern with the microscope. The test pattern has a plurality of uniquely identifiable positions across a plurality of repeating and overlapping 2D sub-patterns. The method determines an image contrast metric from the captured image in a selected patch of the test pattern and a reference contrast metric in the corresponding region; and (iii) determines a normalised contrast metric using the reference contrast metric and the image contrast metric. The method estimates depths of the two captured images at the plurality of positions using the normalised contrast metrics and a set of predetermined calibration data for a stack of images captured using the test pattern at a range of depths, and calibrates the microscope using a comparison of the determined depth estimates for the at least two images.

### REFERENCE TO RELATED PATENT APPLICATION(S)

This application claims the benefit under 35 U.S.C. §119 of the filing date of Australian Patent Application No. 2013254920, filed Nov. 7, 2013, hereby incorporated by reference in its entirety as if fully set forth herein.

### TECHNICAL FIELD

The current invention relates to calibration of a digital imaging device, and finds particular application in the calibration of a microscope. Calibration can be used to measure and correct alignment and other optical properties of an imaging device. It can improve the efficiency and accuracy of the capture of images of a specimen and subsequent post-processing of those images.

### BACKGROUND

Virtual microscopy is a technology that gives physicians the ability to navigate and observe a biological specimen at different simulated magnifications and through different three-dimensional (3D) views as though they were controlling a microscope. Virtual microscopy can be achieved using a display device such as a computer monitor or tablet device with access to a database of microscope images of the specimen. There are a number of advantages of virtual microscopy over traditional microscopy. With virtual microscopy, the specimen itself is not required at the time of viewing, thereby facilitating archiving, telemedicine and education. Virtual microscopy can also enable the processing of the specimen images to change the depth of field and to reveal pathological features that would be otherwise difficult to observe by eye, for example as part of a computer aided diagnosis system.

The capture of images for virtual microscopy is generally performed using a high throughput slide scanner. The specimen is loaded mechanically onto a stage and moved under the microscope objective as images of different parts of the specimen are captured on a sensor. Adjacent images have an overlap region so that the multiple images of the same specimen can be combined into a 3D volume representation by a computer system attached to the microscope. If the specimen movement can be controlled sufficiently accurately, these images theoretically could be combined directly to give a seamless 3D view without any defects. Typically this is not the case as specimen movement and optical tolerances of the imaging device introduce geometrical distortions such as errors in position and rotation of the neighbouring images. Generally software algorithms are required to process the images to register both the neighbouring images at the same depth and at different depths so that there are no defects between adjoining images.

Microscopy is different from other image mosaicking tasks in a number of important ways. Firstly, the subject (specimen) is typically moved by the stage under the optics, rather than the optics being moved to capture different parts of the subject, as would take place in the capture of a panorama view. The stage movement can be controlled very accurately and the specimen may be fixed in a substrate. Also, the microscope is used in a controlled environment—for example mounted on vibration isolation platform in a laboratory with a custom illumination set up so that the optical tolerances of the imaging system (alignment and orientation of optical components and the stage) are very tight. With such arrangements, the coarse alignment of the captured image tiles for mosaicking can be fairly accurate, the lighting even, and the transform between the tiles well represented by a rigid transform. On the other hand, the scale of certain important features of a specimen can be of the order of several pixels and the features can be densely arranged over the captured tile images. This means that the required stitching accuracy for virtual microscopy is very high. Additionally, given that the microscope can be loaded automatically and operated in batch mode, the processing throughput requirements are also high.

The image registration process compares the pixels in the overlapping regions between two neighbouring images to determine the relative deformations in the images. In some systems all pixels in the overlapping regions in both images are used to calculate this deformation. However, the speed of the process can be significantly improved by only taking measurements at small image patches within the overlap region. These patch-based techniques can be an order of magnitude faster and, additionally, when the distortions present in the image are small, as is the case in a microscope, they can be highly accurate.

With improvements in sensor technology and optical components, it has become possible to capture images of increasingly large areas of a specimen with a single shot. However any misalignment of the focal plane relative to the imaged specimen due, for example, to unwanted tilts on the components, when combined with a narrow depth of field, is magnified due to the increased capture area. One means of improving the efficiency and accuracy of the microscope capture is to measure the alignment and optical distortions in the microscope and, if possible, to correct for the systematic errors introduced by such mis-alignment and distortion.

Depth may be measured in a microscope based on a focus function which measures the local contrast or sharpness in the field of view. The axial location at which the focus function is greatest defines the position of best focus, which may be considered to show the depth of a thin specimen. Many focus functions have been described in the literature including the normalised variance. However, in order to accurately determine the location of best focus using this approach many images must be captured at different depths, including one or more images on each side of the best focus. This limits the efficiency of depth estimation methods that use auto-focus techniques to avoid capturing unnecessary images.

Other depth estimation methods are known based on active illumination and aperture masks, however these techniques require additional components that are not required in a standard microscope set up.

A need therefore exists for efficient and accurate methods of calibrating a microscope that do not require additional components.

### SUMMARY

According to one aspect of the present disclosure there is provided a method of calibrating a microscope using a test pattern. The method includes:
(a) capturing a plurality of images of the test pattern through an optical system of the microscope, said test pattern having a plurality of uniquely identifiable positions across the pattern defined by a plurality of repeating and overlapping 2D sub-patterns;
(b) for each of a plurality of corresponding positions on at least two captured images:
   selecting a patch in the captured image at a position selected from the plurality of uniquely identifiable positions on the test pattern and a corresponding region in the test pattern whereby a location for the corresponding region is determined by the plurality of repeating and overlapping 2D sub-patterns in the test pattern;
   determining an image contrast metric from the captured image of the test pattern in the selected patch and a reference contrast metric of the test pattern in the corresponding region; and
   determining a normalised contrast metric using the reference contrast metric and the image contrast metric, said normalised contrast metric compensating for an effect of local non-uniform texture of the test pattern;
(c) estimating depths of the at least two captured images at the plurality of positions using the normalised contrast metrics and a set of predetermined calibration data for a stack of images captured using the test pattern at a range of depths; and
(d) calibrating the microscope using a comparison of the determined depth estimates for the at least two images.

Preferably the plurality of images are captured as pairs of images in which an axial offset is imparted to a stage of the microscope between the captures. More specifically, step (c) comprises estimating a plurality of depths for each position of each image of the pair based on the normalised contrast metrics of the pair of images, and resolving the depths into a single estimate of depth for each of the positions.

Desirably the depth estimates for each of the plurality of positions of the at least one captured image form a warp map for that image.

In a specific implementation, the method further comprises:
capturing the stack of images of the test pattern at least spanning depths above and below a depth of best focus of the microscope;
generating the predetermined calibration data for each of the plurality of positions on each of the captured stack images by:
   (i) forming a transverse warp map for each stack image;
   (ii) forming normalised contrast data from the transverse warp map; and
   (iii) analysing the normalised contrast data to form the predetermined calibration data.

In this case, the forming of the normalised contrast data may comprise:
selecting a patch in the captured stack image of the test pattern at a position selected from the plurality of uniquely identifiable positions on the test pattern and a corresponding region in the test pattern whereby a location for the corresponding region is determined by the plurality of repeating and overlapping 2D sub-patterns in the test pattern;
determining an image contrast metric from the captured stack image in the selected patch and a reference contrast metric of the test pattern in the corresponding region; and
determining a normalised contrast metric based on the reference contrast metric and the image contrast metric, said normalised contrast metric compensating for an effect of local non-uniform texture of the test pattern.

Typically multiple determined depth offsets across different positions on the captured image plane define a warp map between 2D positions of a sensor of the microscope and 3D positions in the focal plane of the microscope with reference to the test pattern.

Advantageously step (c) comprises comparing at least an estimated pair of depths with a depth offset known from the predetermined calibration data to determine a single depth estimate for current position. Here, the method may further comprise adjusting a configuration of the microscope between capture of the images.

Other aspects are also disclosed.

### BRIEF DESCRIPTION OF THE DRAWINGS

At least one embodiment of the present invention will now be described with reference to the following drawings, in which:

FIG. 1 shows a high-level system diagram of a microscope image capture system;

FIG. 2 is a schematic flow diagram of a process for calibration of a microscope in the system of FIG. 1;

FIGS. 3A to 3E illustrate the generation of a test pattern for a calibration target suitable for use in the calibration of a microscope;

FIG. 4 is a schematic flow diagram of a method of generating calibration data for the microscope by analysing one or more image stacks;

FIG. 5 is a schematic flow diagram of a method for generating a 3D warp map;

FIG. 6 is a schematic flow diagram of a method of analysing an image of a calibration target to generate a transverse warp map;

FIG. 7 is a schematic flow diagram of a method of coarse alignment for a calibration target;

FIG. 8 is a schematic flow diagram of a method of analysing an image of a calibration target to generate normalised contrast data based on the analysis of image patches;

FIGS. 9A and 9B illustrate the fitting of normalised contrast metrics to a focus function and the corresponding inverse function that may be used for depth estimation;

FIG. 10 illustrates shift estimation for a pair of patches;

FIG. 11 is a schematic flow diagram of a method of determining calibration parameters for a microscope;

FIG. 12 is a schematic flow diagram of a method of determining calibration parameters for a microscope;

FIGS. 13A to 13C illustrate transverse alignment grid locations over an image region;

FIG. 14 illustrates a particular microscope configuration and in particular some components that may be tuned according to the calibration process;

FIGS. 15A and 15B form a schematic block diagram of a general purpose computer system of FIG. 1 upon which arrangements described can be practiced; and

FIG. 16 is a histogram of 2D ruler normalisation.

### DETAILED DESCRIPTION INCLUDING BEST MODE

### Context

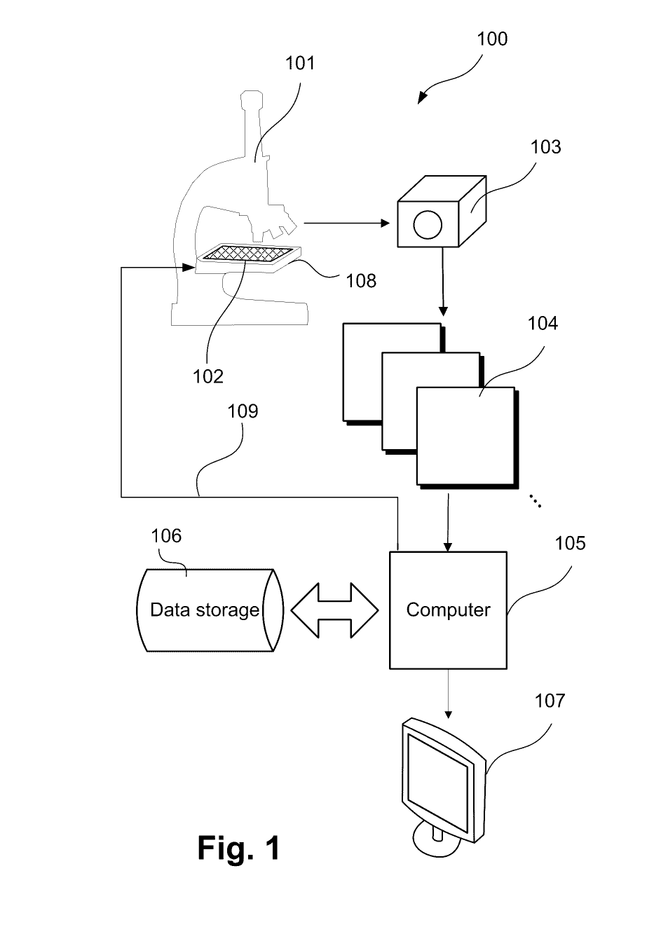

FIG. 1 shows a high-level system diagram for a general microscope capture system 100. A calibration target 102 is a substrate with a known, precisely etched test pattern formed on its surface. The calibration target 102 is physically positioned on a movable stage 108 that is under an optical system, such as the lens, of a microscope 101. Ideally, the calibration target 102 has a spatial extent equal to or larger than the field of view of the microscope 101 in the transverse directions x and y forming the plane of the calibration target 102.

The stage 108 of the microscope 101 may move as multiple images 104 of the calibration target 102 are captured by a camera 103 mounted to the microscope 101. The camera 103 takes one or more images at each stage location. The multiple images can be taken with different optical settings or using different types of illumination. The captured images 104 are passed to a computer system 105 which can either start processing the images 104 immediately or store them in a storage 106 for later processing. The computer system 105 is typically configured to control movement of the stage 108 in each of the X, Y and Z directions, as depicted in FIG. 1 via a control connection 109.

The computer 105 generates a 3D warp map for one or more of the captured images. The 3D warp map defines the relationship between the position of focus corresponding to the pixels captured by the sensor of the microscope 101 and true locations on the calibration target 102. The computer 105 uses the warp maps to determine calibration parameters for the microscope 101 which may be used to mechanically tune the microscope 101. A display device 107 is coupled to the computer 105 to permit reproduction of any of the captured images 104, together with any spliced images thereof formed by the computer 105 or warp maps and the like.

The depth of field of the microscope 101 may be estimated based on the optical configuration of the microscope 101. A standard approximation to this depth of field D is given by the following relationship:

$$D = \frac{λ n}{{NA}^{2}} \qquad ( 1 )$$

where NA is the numerical aperture, n is the refractive index in the medium (n=1.0 for air immersion or may be higher if the lens is immersed, for example in oil) and λ is the wavelength of light in the microscope. For air immersion, with an NA of 0.7 and a wavelength of 500 nm, the estimated depth of field is 1 micron. The captured images 104 may span depths from this distance above and below the best focus of the calibration target 102, which forms a two-dimensional (2D) ruler for accurate measurements in the image plane.

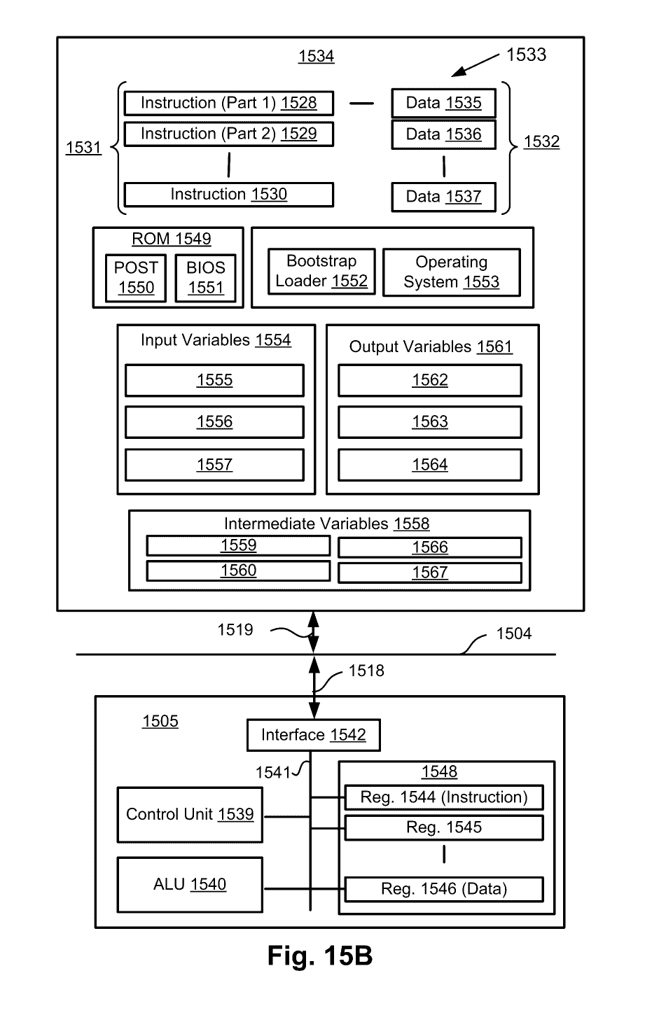

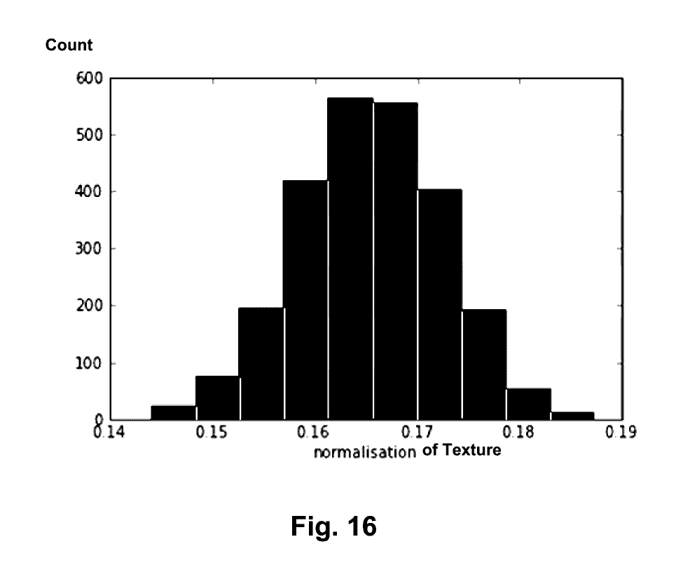

FIGS. 15A and 15B depict a general-purpose computer system 1500, upon which the various arrangements described can be practiced.

As seen in FIG. 15A, the computer system 1500 includes: the computer module 105; input devices such as a keyboard 1502, a mouse pointer device 1503, a scanner 1526, the camera 103, and a microphone 1580; and output devices including a printer 1515, the display device 107 and loudspeakers 1517. An external Modulator-Demodulator (Modem) transceiver device 1516 may be used by the computer module 105 for communicating to and from a communications network 1520 via a connection 1521. The communications network 1520 may be a wide-area network (WAN), such as the Internet, a cellular telecommunications network, or a private WAN. Where the connection 1521 is a telephone line, the modem 1516 may be a traditional “dial-up” modem. Alternatively, where the connection 1521 is a high capacity (e.g., cable) connection, the modem 1516 may be a broadband modem. A wireless modem may also be used for wireless connection to the communications network 1520. As desired in some implementations, the camera 103 may couple directly to the network 1520 via which the images 104 are transferred to the computer 105. In this fashion the computer 105 may be a server-type device implemented in a cloud computing environment for image processing.

The computer module 105 typically includes at least one processor unit 1505, and a memory unit 1506. For example, the memory unit 1506 may have semiconductor random access memory (RAM) and semiconductor read only memory (ROM). The computer module 105 also includes an number of input/output (I/O) interfaces including: an audio-video interface 1507 that couples to the video display 107, loudspeakers 1517 and microphone 1580; an I/O interface 1513 that couples to the keyboard 1502, mouse 1503, scanner 1526, camera 103 and optionally a joystick or other human interface device (not illustrated); and an interface 1508 for the external modem 1516 and printer 1515. In some implementations, the modem 1516 may be incorporated within the computer module 105, for example within the interface 1508. The computer module 105 also has a local network interface 1511, which permits coupling of the computer system 1500 via a connection 1523 to a local-area communications network 1522, known as a Local Area Network (LAN). As illustrated in FIG. 15A, the local communications network 1522 may also couple to the wide network 1520 via a connection 1524, which would typically include a so-called “firewall” device or device of similar functionality. The local network interface 1511 may comprise an Ethernet circuit card, a Bluetooth™ wireless arrangement or an IEEE 802.11 wireless arrangement; however, numerous other types of interfaces may be practiced for the interface 1511.

Where desired or appropriate the control connection 109 between the computer and the stage 108 of the microscope 101 may be via a connection to the either of the networks 1520 or 1522 or via a direct connection (not illustrated) to the I/O interface 1513 for example.

The I/O interfaces 1508 and 1513 may afford either or both of serial and parallel connectivity, the former typically being implemented according to the Universal Serial Bus (USB) standards and having corresponding USB connectors (not illustrated). Storage devices 1509 are provided and typically include a hard disk drive (HDD) 1510. Other storage devices such as a floppy disk drive and a magnetic tape drive (not illustrated) may also be used. An optical disk drive 1512 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 1500. With reference to the arrangement of FIG. 1, the data storage 106 may be implemented using the HDD 1510, the memory 1506, or in a remote fashion upon either one or both of the networks 1520 and 1522.

The components 1505 to 1513 of the computer module 105 typically communicate via an interconnected bus 1504 and in a manner that results in a conventional mode of operation of the computer system 1500 known to those in the relevant art. For example, the processor 1505 is coupled to the system bus 1504 using a connection 1518. Likewise, the memory 1506 and optical disk drive 1512 are coupled to the system bus 1504 by connections 1519. Examples of computers on which the described arrangements can be practised include IBM-PC's and compatibles, Sun Sparcstations, Apple Mac™ or a like computer systems.

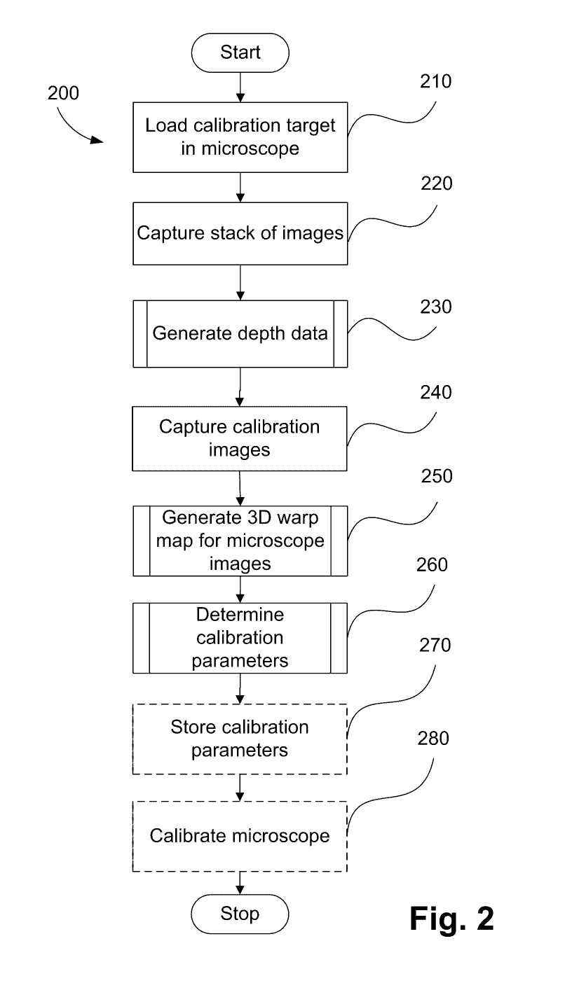

The methods of image processing and microscope calibration to be described may be implemented using the computer system 1500 wherein the processes of FIGS. 2 to 14 may be implemented as one or more software application programs 1533 executable within the computer system 1500, and particularly upon the computer 105. In particular, the steps of the methods are effected by instructions 1531 (see FIG. 15B) in the software 1533 that are carried out within the computer system 1500. The software instructions 1531 may be formed as one or more code modules, each for performing one or more particular tasks. The software may also be divided into two separate parts, in which a first part and the corresponding code modules performs the image processing and calibration methods and a second part and the corresponding code modules manage a user interface between the first part and the user.

The software may be stored in a computer readable medium, including the storage devices described below, for example. The software is loaded into the computer system 1500 from the computer readable medium, and then executed by the computer system 1500. A computer readable medium having such software or computer program recorded on the computer readable medium is a computer program product. The use of the computer program product in the computer system 1500 preferably effects an advantageous apparatus for image processing and microscope calibration.

The software 1533 is typically stored in the HDD 1510 or the memory 1506. The software is loaded into the computer system 1500 from a computer readable medium, and executed by the computer system 1500. Thus, for example, the software 1533 may be stored on an optically readable disk storage medium (e.g., CD-ROM) 1525 that is read by the optical disk drive 1512. A computer readable medium having such software or computer program recorded on it is a computer program product. The use of the computer program product in the computer system 1500 preferably effects an apparatus for image processing and microscope calibration.

In some instances, the application programs 1533 may be supplied to the user encoded on one or more CD-ROMs 1525 and read via the corresponding drive 1512, or alternatively may be read by the user from the networks 1520 or 1522. Still further, the software can also be loaded into the computer system 1500 from other computer readable media. Computer readable storage media refers to any non-transitory tangible storage medium that provides recorded instructions and/or data to the computer system 1500 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computer module 105. Examples of transitory or non-tangible computer readable transmission media that may also participate in the provision of software, application programs, instructions and/or data to the computer module 105 include radio or infra-red transmission channels as well as a network connection to another computer or networked device, and the Internet or Intranets including e-mail transmissions and information recorded on Websites and the like.

The second part of the application programs 1533 and the corresponding code modules mentioned above may be executed to implement one or more graphical user interfaces (GUIs) to be rendered or otherwise represented upon the display 107. Through manipulation of typically the keyboard 1502 and the mouse 1503, a user of the computer system 1500 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1517 and user voice commands input via the microphone 1580.

FIG. 15B is a detailed schematic block diagram of the processor 1505 and a “memory” 1534. The memory 1534 represents a logical aggregation of all the memory modules (including the HDD 1509 and semiconductor memory 1506) that can be accessed by the computer module 105 in FIG. 15A.

When the computer module 105 is initially powered up, a power-on self-test (POST) program 1550 executes. The POST program 1550 is typically stored in a ROM 1549 of the semiconductor memory 1506 of FIG. 15A. A hardware device such as the ROM 1549 storing software is sometimes referred to as firmware. The POST program 1550 examines hardware within the computer module 105 to ensure proper functioning and typically checks the processor 1505, the memory 1534 (1509, 1506), and a basic input-output systems software (BIOS) module 1551, also typically stored in the ROM 1549, for correct operation. Once the POST program 1550 has run successfully, the BIOS 1551 activates the hard disk drive 1510 of FIG. 15A. Activation of the hard disk drive 1510 causes a bootstrap loader program 1552 that is resident on the hard disk drive 1510 to execute via the processor 1505. This loads an operating system 1553 into the RAM memory 1506, upon which the operating system 1553 commences operation. The operating system 1553 is a system level application, executable by the processor 1505, to fulfil various high level functions, including processor management, memory management, device management, storage management, software application interface, and generic user interface.

The operating system 1553 manages the memory 1534 (1509, 1506) to ensure that each process or application running on the computer module 105 has sufficient memory in which to execute without colliding with memory allocated to another process. Furthermore, the different types of memory available in the system 1500 of FIG. 15A must be used properly so that each process can run effectively. Accordingly, the aggregated memory 1534 is not intended to illustrate how particular segments of memory are allocated (unless otherwise stated), but rather to provide a general view of the memory accessible by the computer system 1500 and how such is used.

As shown in FIG. 15B, the processor 1505 includes a number of functional modules including a control unit 1539, an arithmetic logic unit (ALU) 1540, and a local or internal memory 1548, sometimes called a cache memory. The cache memory 1548 typically include a number of storage registers 1544-1546 in a register section. One or more internal busses 1541 functionally interconnect these functional modules. The processor 1505 typically also has one or more interfaces 1542 for communicating with external devices via the system bus 1504, using a connection 1518. The memory 1534 is coupled to the bus 1504 using a connection 1519.

The application program 1533 includes a sequence of instructions 1531 that may include conditional branch and loop instructions. The program 1533 may also include data 1532 which is used in execution of the program 1533. The instructions 1531 and the data 1532 are stored in memory locations 1528, 1529, 1530 and 1535, 1536, 1537, respectively. Depending upon the relative size of the instructions 1531 and the memory locations 1528-1530, a particular instruction may be stored in a single memory location as depicted by the instruction shown in the memory location 1530. Alternately, an instruction may be segmented into a number of parts each of which is stored in a separate memory location, as depicted by the instruction segments shown in the memory locations 1528 and 1529.

In general, the processor 1505 is given a set of instructions which are executed therein. The processor 1505 waits for a subsequent input, to which the processor 1505 reacts to by executing another set of instructions. Each input may be provided from one or more of a number of sources, including data generated by one or more of the input devices 1502, 1503, data received from an external source across one of the networks 1520, 1502, data retrieved from one of the storage devices 1506, 1509 or data retrieved from a storage medium 1525 inserted into the corresponding reader 1512, all depicted in FIG. 15A. The execution of a set of the instructions may in some cases result in output of data. Execution may also involve storing data or variables to the memory 1534.

The disclosed image processing and microscope calibration arrangements use input variables 1554, which are stored in the memory 1534 in corresponding memory locations 1555, 1556, 1557. The arrangements produce output variables 1561, which are stored in the memory 1534 in corresponding memory locations 1562, 1563, 1564. Intermediate variables 1558 may be stored in memory locations 1559, 1560, 1566 and 1567.

Referring to the processor 1505 of FIG. 15B, the registers 1544, 1545, 1546, the arithmetic logic unit (ALU) 1540, and the control unit 1539 work together to perform sequences of micro-operations needed to perform “fetch, decode, and execute” cycles for every instruction in the instruction set making up the program 1533. Each fetch, decode, and execute cycle comprises:
a fetch operation, which fetches or reads an instruction 1531 from a memory location 1528, 1529, 1530;
(ii) a decode operation in which the control unit 1539 determines which instruction has been fetched; and
(iii) an execute operation in which the control unit 1539 and/or the ALU 1540 execute the instruction.

Thereafter, a further fetch, decode, and execute cycle for the next instruction may be executed. Similarly, a store cycle may be performed by which the control unit 1539 stores or writes a value to a memory location 1532.

Each step or sub-process in the processes of FIGS. 2 to 14 is associated with one or more segments of the program 1533 and is performed by the register section 1544, 1545, 1547, the ALU 1540, and the control unit 1539 in the processor 1505 working together to perform the fetch, decode, and execute cycles for every instruction in the instruction set for the noted segments of the program 1533.

### Detail

A general overview of a method 200 that can be used to perform a calibration of a microscope is shown in FIG. 2. At an initial step 210, an appropriate calibration target 102 is loaded onto the microscope stage such that the patterned region is in the field of view and roughly in focus. This step may be performed manually, but in a manufacturing environment of the microscope 101, such may be performed robotically under computerized control, for example by the computer 105. The balance of the method 200 is typically computer-implemented by the computer 105 using software that is stored on the HDD 1510 and executed by the processor 1505 making use of the images 104 that have been otherwise saved or loaded to the memory 1506 or HDD 1510.

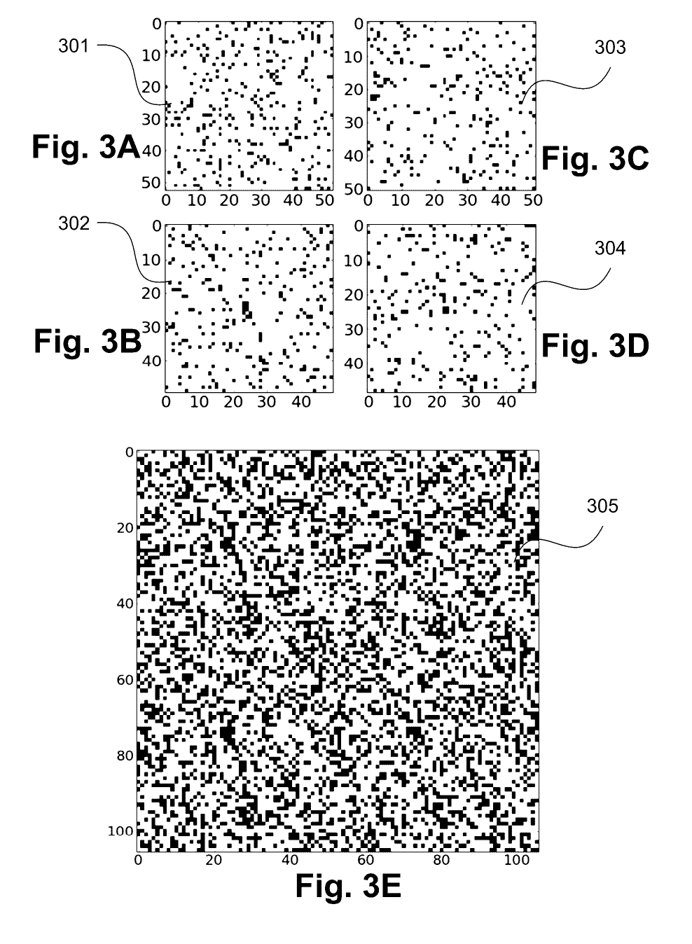

FIGS. 3A to 3E illustrate how a suitable test pattern 305 for the calibration target 102 may be generated. Regions 301 (FIG. 3A) to 304 (FIG. 3D) show pseudo-random two dimensional binary patterns represented as black and white pixels. The sizes of the patterns (i.e. the number of pixels in a pattern) are different from each other and the patterns do not share a common factor. Each of the patterns 301-304 are square in shape and can be used to tile a larger region by repeating the pattern over the extent of the larger region. These larger regions can then be overlayed or overlapped and combined together using one or more Boolean operations such as ‘AND’ or ‘OR’. This generates a pseudo-random pattern that is non-periodic over a region given by the product of the sizes of the individual patterns 301, 302, 303 and 304. As a consequence, such a pattern has uniquely identifiable positions across the pattern defined by a plurality of repeating and overlapping 2D sub-patterns. This pattern, an example of which is illustrated by a pattern 305 seen in FIG. 3E, is a test pattern and may be referred to as a 2D ruler and is suitable for use in forming a suitable calibration target 102. Typically, the test pattern 305 is etched onto a substrate to form the calibration target 102. In this example, the 2D ruler has a range from pixel location 0 to 105 in each dimension (i.e. 106×106 pixels). In practical use, a much larger patterned region would be used, for example 2500×2500 pixels or more.

One useful property of the 2D ruler is that an accurate transverse location may be determined for a captured image of a region of the ruler (test pattern 305) that is at least as large as all of the tiled patterns used to generate the ruler, and where distortions of the captured image relative to the test pattern are not too large. Methods for determining the location of a patch region of the captured image are described later with reference to steps 635 to 650 of method 600. A second useful property of the 2D ruler is that the test pattern (e.g. 305) can be configured to have a high level of non-uniform texture everywhere, making the 2D ruler amenable to analysis using a focus function for depth estimation. An example of the disperse non-uniform texture is seen in FIG. 3E for which a normalised histogram is seen in FIG. 16 from which it will be observed that the count values for the texture are non-uniform, notwithstanding that some counts are close to matching others.

For the case where the microscope 101 is a transmission microscope, the calibration target 102 may be manufactured by accurately etching the pattern from a thin layer such as chrome on a glass or other flat transparent substrate. The pixel features of the calibration target 102 should be larger than the resolution of the microscope. For example, in a microscope with a 0.5 micron resolution the pixel features may typically be 1 or 2 microns in size. A pattern formed using a layer of chrome as thin as 0.5 microns may be sufficient to substantially prevent transmission of light where the chrome remains.

Returning to FIG. 2, one or more stacks of the images 104 of the 2D ruler (the calibration target 102 formed of the test pattern 305) are captured at step 220 using the camera 103. Each stack of the images 104 is taken at a single transverse stage location (i.e. with a common field of view) over a series of depths, hence the use of the descriptor “stack”. The set of depths is desirably configured to span a range of focus extending from one side to the other side of a best focus of the current view of the 2D ruler, and is desirably larger than the depth of field of the microscope 101. For example, for a typical microscope set up with a magnification of 20, an air immersion lens with a numerical aperture (NA) of 0.7 (for which the depth of field is 1.0 microns), the stack can consist of 10 capture layers over a range 10 or 20 microns centred near the best focus of the current view of the 2D ruler. Multiple stacks of images may be taken at different environmental conditions (e.g. temperature), and/or wavelengths of light (for example by illuminating at a specific wavelength). Also, in the case that the microscope 101 includes multiple sensors for simultaneous capture, stacks of the images 104 may be captured for each sensor. In the latter case, the capture field of view of the multiple sensors may be offset in the transverse or axial directions, or both, depending on the optical design of the microscope 101.

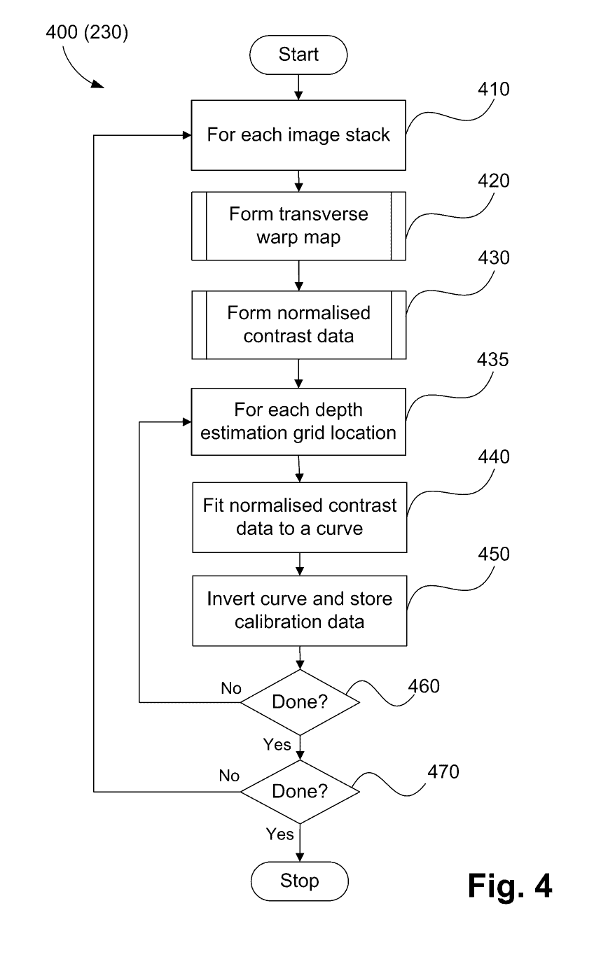

After the stacks of the images 104 have been captured at step 220, each stack is analysed at step 230 to generate depth calibration data for the microscope 101. Step 230 will be described in further detail below with reference to method 400 and FIG. 4. The calibration data is used to estimate depth for a set of microscope configurations and stage positions at step 250.

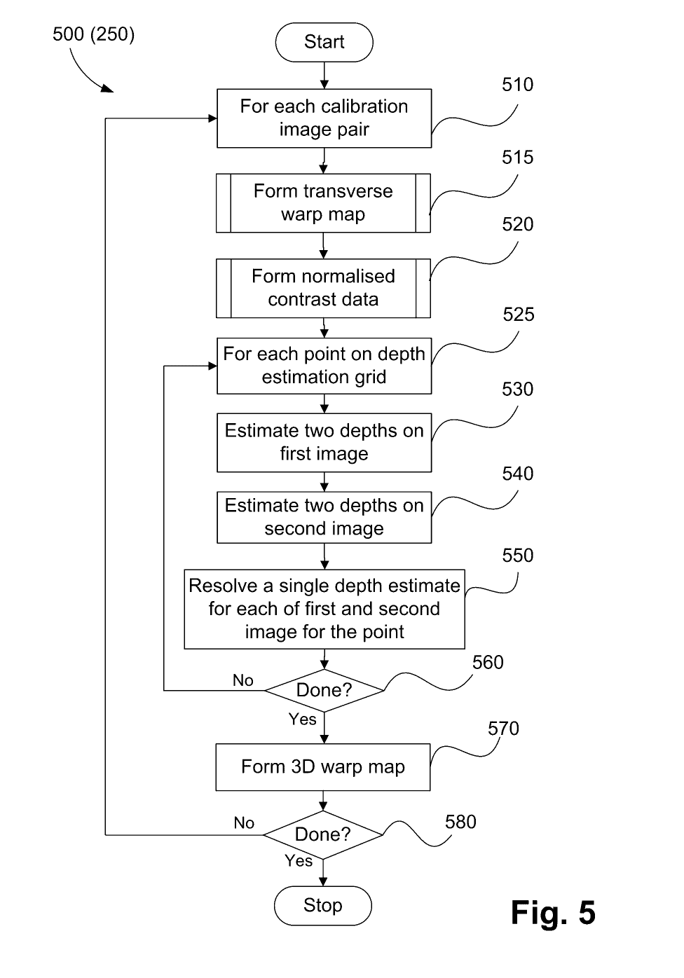

Next, at step 240, a set of further images 104 are captured using the camera 103. These further images captured at step 240 are referred to herein as a set of “calibration” images. The set of calibration images include captured images of the test pattern 305 of the calibration target 102 at a constant stage depth, but at different stage locations and for a variety of configurations of the microscope 101 (e.g. different tilts and transverse shifts of the pattern). The set of calibration images captured at step 240 are therefore different from the stack of images captured at step 220. The exact set of configurations depends on the details of the calibration task being performed. The calibration images are captured in pairs, with an axial stage offset being the only change in configuration between the image captures. Manipulation of the microscope 101 while sets of calibration images are captured is described in further detail below within the discussion of methods 1100 and 1200. At step 250, the calibration images captured at step 240 are analysed in pairs to create 3D warp map data. This step will be described in further detail below with reference to method 500 and FIG. 5.

Once a set of 3D warp maps for microscope images have been generated, processing continues to step 260 which determines a set of calibration parameters for the microscope. Depending on the precise calibration procedure being employed, the calibration parameters may take a number of forms, including:
(i) optimised configurations and settings for the optical components of the microscope;
(ii) parameters of functions that describe the behaviour of the microscope with wavelength or environmental conditions such as temperature; or
(iii) parameters of transforms relating to the image capture region or motion of components of the microscope 101.

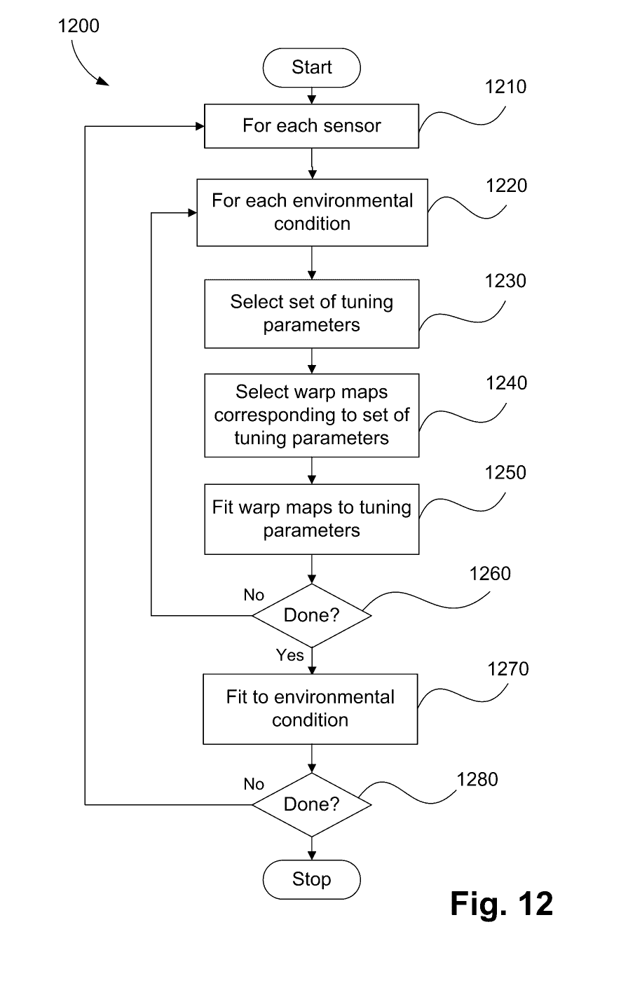

Method 1100, illustrated by the schematic flow diagram in FIG. 11, describes one method of determining calibration parameters suitable for use at step 260. Method 1200, illustrated by the schematic flow diagram in FIG. 12 describes a second, alternative method of determining calibration parameters for use at step 260.

The calibration parameters determined at step 260 may be stored at step 270 in the data storage 106 for use later during the microscope operation. Alternatively, the calibration parameters may be used directly to calibrate the microscope 101 by tuning the configuration and settings of the microscope 101 accordingly at step 280.

An exemplary method 400, used at step 230 to generate depth calibration data for the microscope by analysing one or more image stacks, will now be described in further detail below with reference to FIG. 4. The method 400 is preferably implemented using software executed by the process 1505 and establishes a loop structure to process each image stack in turn, the loop starting at step 410 which selects the next image stack captured at step 220 for processing. The selection extracts the images of the stack for example from the HDD 1510 and loads the images to the memory 1506 for ready access by the processor 1505.

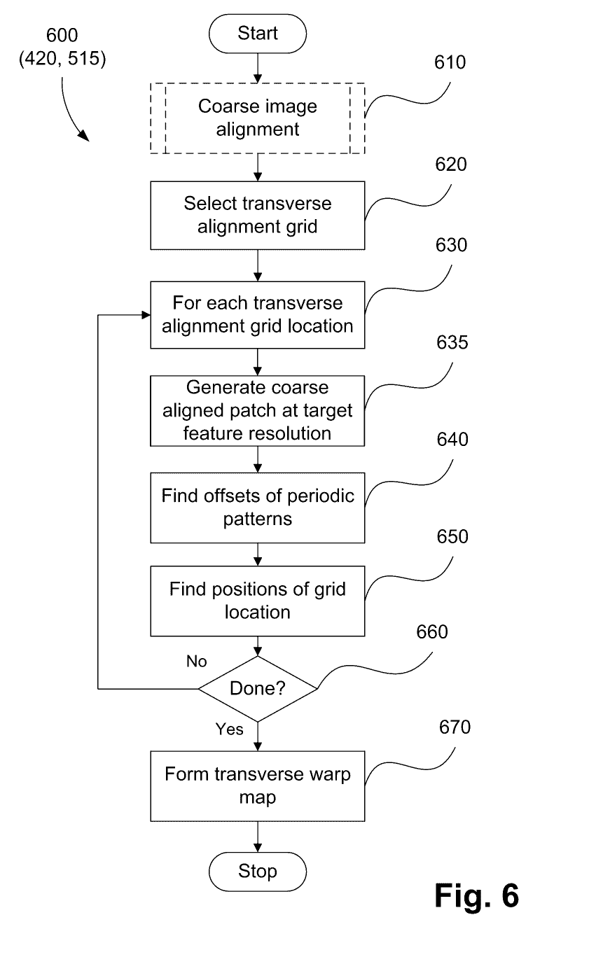

At step 420, a transverse warp map is generated by the processor 1505 for each of the images in the selected image stack. The transverse warp map may take the form of an affine, projective, or nonlinear transform that maps coordinates defined in pixels of the sensor image and coordinates in the space of the 2D ruler pattern and when generated may be stored in the HDD 1510 of each image of the selected image stack. FIG. 6 is a schematic flow diagram that illustrates a method 600 suitable for analysing an image of a calibration target to generate such a transverse warp map. This method may be used at step 420 for each of the calibration stack images in turn.

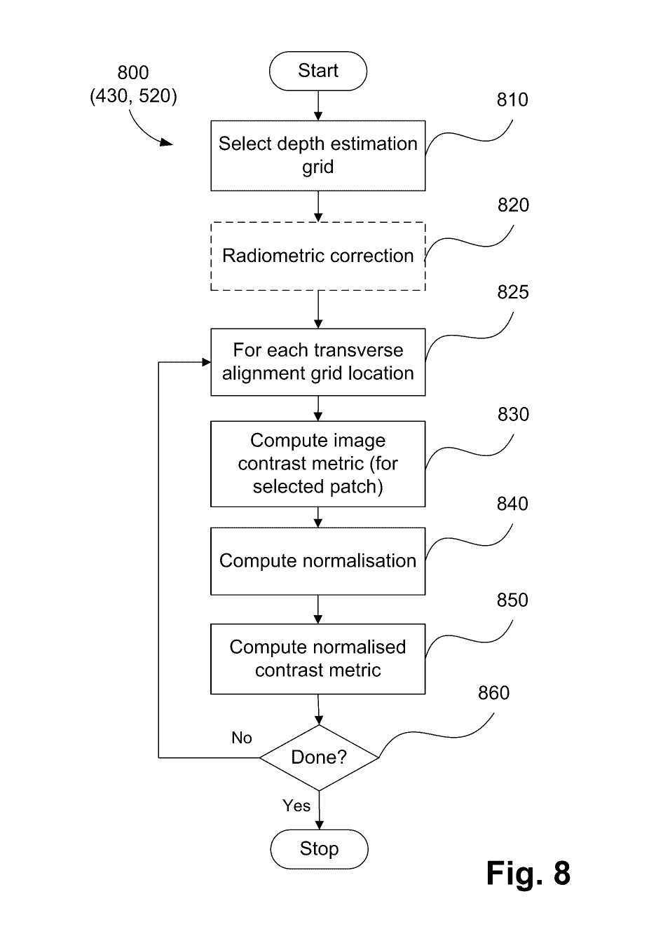

At step 430, the transverse warp map data from step 420 is used to generate normalised contrast data for each image in the stack. The normalised contrast data may take the form of a metric established from a scalar value at each point on a grid of transverse locations selected for depth estimation (the depth estimation grid). FIG. 8 is a schematic flow diagram that illustrates a method 800 suitable for analysing an image of a calibration target to generate such normalised contrast metric data based on the analysis of image patches around the grid location. This method may be used at step 430 for each of the calibration stack images in turn.

Starting at step 435, a further loop structure is used by the method 400 to analyse the normalised contrast data at each of the depth estimation grid locations separately to form calibration data for the grid location. Step 440 selects the set of normalised contrast data for each image in the stack at the current depth estimation grid location. A fit is made to these values as a function of the depth of the images in the stack. A suitable fit function is based on an offset modified Gaussian function F(z):

F(z)=p₀e^{-p}^{₁}^{|z-p}^{₂}^{|}^{^{p}}⁴+|p₃| (2)

where z is the depth and the parameters pᵢ are the parameters of the fit to the normalised contrast data values. A nonlinear fitting method may be used to create the function fit, for example the parameters of the fit may be found by minimising the mean square error between the normalised contrast values and the fit function using a downhill simplex algorithm

An alternative function fit that may be used can be asymmetric in the depth parameter. For example such an alternative function fit may be based on an asymmetric Gaussian function, such as:

F(z)=p₀e^{-p(z)|z-p}^{₂}^{|}^{^{p4}}+|p₃| (3)

where the function p(z) may be different on each side of the peak focus depth p₂, based on a step function, or a smooth function such as a hyperbolic tangent.

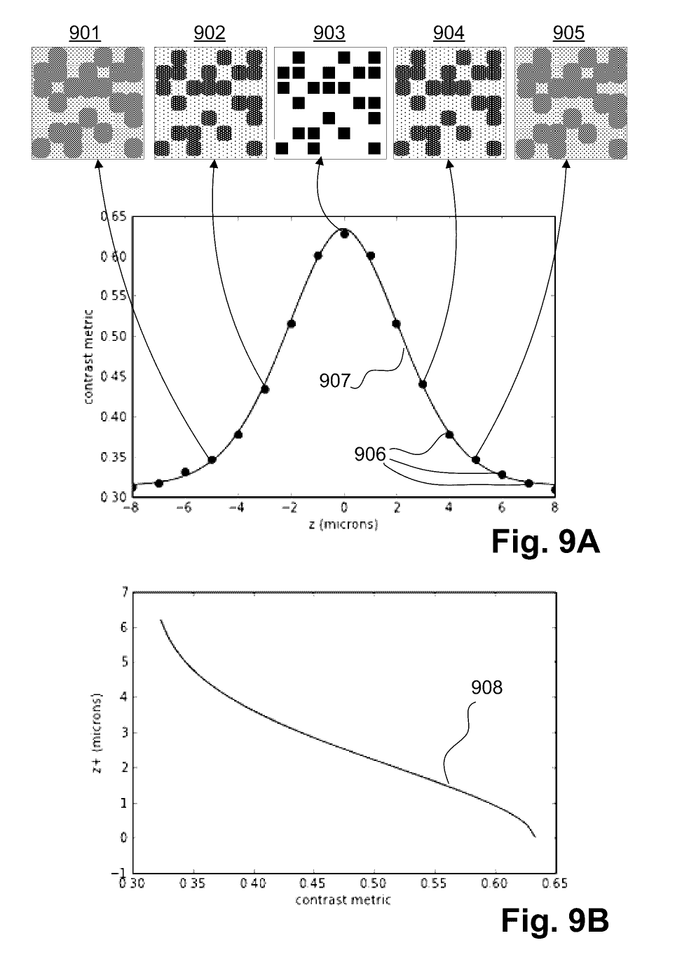

A plot shown in FIG. 9A illustrates the fitting of normalised contrast metrics to a focus function. The dots 906 on the plot (only some of which are identified), represent the calculated normalised metric values at a discrete set of depths from −8 to 8 microns around a nominal central point (z=0) near the best focus. The line 907 represents an offset modified Gaussian (focus) function fit to the data. The image patches 901 to 905 represent the patches from captured images used to calculate the normalised contrast values around the depths −5, −3, 0, 3 and 5 μm and will be discussed further below with reference to step 830 of method 800.

Returning to method 400, the functional fit (e.g. 907) to the normalised contrast data created at step 440 is inverted at step 450 to give a second function that may be used to estimate depth based on a normalised contrast value, referred to as the calibration function. The parameters of this function are stored in step 450 in the data storage 106 as (depth) calibration data for later use. For the offset modified Gaussian function this inverse function is given by:

$${z}_{\pm } ( F ) = {p}_{2} \pm {{p}_{1}^{2} ( - log ( \frac{F - \vert {p}_{3} \vert}{{p}_{0}} ) )}^{1 / {p}_{4}} . \qquad ( 4 )$$

This function gives two solutions, taking the principle branches for the logarithm and power, one on either side of the best focus at a depth of p₂. FIG. 9B illustrates the solution z₊ plotted as a function 908 the normalised contrast metric corresponding to the functional fit shown in FIG. 9A. Using the inverse function of Eqn. 4 it is possible to determine the solution depth (z+) corresponding to a patch image of the test pattern based on the normalised contrast metric, being a depth offset value that can be used to calibrate the microscope 101 according to step 280. For some fit functions, it may not be possible to express the inverse function analytically. The solution depth (z+) represents the depth of the test patch of the capture image relative to the best focus of the microscope 101. The function 908 of FIGS. 9B represents calibration data for the microscope 101. For example the calibration data may be a set of coefficients associated with the function 908 for which the function 980 is invertible.

Following the storage of the parameters of the inverse function fit at step 450, step 460 checks if there are further depth estimation grid locations to process, in which case processing returns to step 435, otherwise processing continues to step 470. Step 470 checks if there are further image stacks to process, in which case processing returns to step 410, otherwise the processing of method 400 ends.

FIG. 5 is a schematic flow diagram that illustrates an exemplary method 500 for generating a 3D warp map, the method 500 being suitable for use at step 250. Method 500 employs a loop structure starting at step 510 to analyse pairs of calibration images for which a known axial stage offset is the only change in microscope configuration between the capture of the calibration images. The known axial offset is referred to as ‘dz’.

At step 515, a transverse warp map is generated for each of the calibration image of the pair of calibration images. The transverse warp map may take the form of an affine, projective, or nonlinear transform that maps coordinates defined in the captured image pixels and coordinates in the space of the 2D ruler pattern. FIG. 6 is a schematic flow diagram that illustrates a method 600 suitable for analysing an image of a calibration target to generate such a transverse warp map. This method may be used at step 515 for each image of the pair of calibration images.

At step 520, the transverse warp map data from step 515 is used to generate normalised contrast data for the calibration image pair. The normalised contrast data may take the form of a scalar value at each point on a grid of transverse locations selected for depth estimation (the depth estimation grid). FIG. 8 is a schematic flow diagram that illustrates a method 800 suitable for analysing a calibration image of a calibration target to generate such normalised contrast data based on the analysis of image patches around the grid location. This method may be used at step 520 for each image of the calibration image pair.

Next, starting at step 525, a loop structure is employed to estimated depths at each of the depth estimation grid locations in turn. At step 530, two depths are estimated at the current depth estimation grid location for the first calibration image of the current pair based on the normalised contrast metric determined for this location at step 520. The two depths are given by solutions above and below the best focus location (z_{±}) based on the known calibration function and corresponding parameter set determined at step 450 at the current grid location. The depths corresponding to the first image are referred to as z_{±}¹. At step 540, the process of 530 is repeated for the second calibration image of the current pair to estimate two depths corresponding to the current grid location referred to as z_{±}².

Next, at step 550, the pairs of depths estimated at steps 530 and 540, z_{±}¹ and z_{±}², are compared with the known depth offset (previously determined as part of the calibration data of step 230, i.e. predetermined calibration data) between the images, dz, to determine a single depth estimate for the current grid location for each calibration image of the current pair. Four error terms, E_{±±}, are calculated as the absolute value of the discrepancy between the depth offset and the difference between the two depth estimates. This may be calculated as follows:

E_{±,±}=|dz−(z_{±}²−z_{±}¹)|, (5)

where first subscript of the error term E_{±,±} refers to the choice of depth for the first image (z_{±}¹), and the second subscript refers to the choice of depth for the first image (z_{±}²). The subscripts corresponding to the smallest value of the error term provide the best choice of depth from the first and second image For example, if z₊¹=2 μm, z₋¹=−2 μm, z₊²=3 μm, z₋²=−1 μm, and dz=1 μm, then E₊₊=−0 μm, E₊₋=6 μm, E₋₊=4 μm, and E₋₋=2 μm. The smallest error term is E₊₊ and so the selected depths are z₊¹ and z₊² (2 μm and 3 μm, respectively) for the two images.

Once the depth estimates for the image pair have been resolved at step 550, step 560 checks if there are more locations on the depth estimation grid, and if so processing returns to step 525, otherwise processing continues to step 570.

In step 570, the processor 1505 forms a 3D warp map based on the depth estimates at the depth estimation grid locations determined at step 550 and the transverse warp map generated at step 515. The 3D warp map may then be stored in the HDD 1510. A suitable method of defining the warp map is to form an axial warp map z(i, j), defining depth of the position of the focal plane corresponding to the i^{th} pixel coordinate along the x-axis and the j^{th} pixel coordinate along the y-axis of the image sensor. The 3D warp map of each image is defined by the axial and transverse warp maps used independently to generate the transverse and axial location corresponding to a pixel location on the sensor.

The simplest form of the axial warp map is a bi-linear function of the sensor pixel coordinates:

z(i, j)=z₀+z₁i+z₂j (6)

where z₀, z₁, and z₂ are the parameters of the linear fit. Given the depth estimation grid locations in pixel coordinates (i, j), and a set of depth estimates, least squares estimates of the parameters of the fit may be determined using standard estimations methods. Alternative functions suitable for the axial warp map include the quadratic function:

z(i, j)=z₀+z₁i+z₂j+z₃i²+z₄ij+z₅j², (7)

and other nonlinear forms. Least squares estimation methods for the parameters of the fit may be used for the quadratic fit. If there are more points in the depth estimation grid than free parameters in the axial warp map function (i.e. 3 for the linear fit, 6 for the quadratic fit) then methods may be used to improve the robustness of the fit to outliers in the depth estimation data. For example, the RANdom Sample Consensus (RANSAC) method is a well known method for robust estimation that can be used to select a subset of the depth estimation grid points for which a more reliable fit may be obtained.

Once the 3D warp map has been generated at step 570, step 580 checks if there are more calibration image pairs to process, and if so processing returns to step 510, otherwise the processing of step 500 ends.

FIG. 6 is a schematic flow diagram that illustrates a method 600 suitable for analysing an image of a calibration target to generate a transverse warp map. This method may be used at either of step 515 and step 420 to analyse images of a calibration target. The transverse warp map may take the form of an affine, projective, or nonlinear transform that maps coordinates defined in sensor image pixels and coordinates in the space of the 2D ruler pattern.

An affine transform is a mapping from a pixel location in one image x=[x, y]^{T}, where x and y are the horizontal and vertical coordinates respectively, to a pixel location in a second image x′=[x′, y′]′^{T} according to the relationship:

$${x}^{′} = [ \begin{matrix}a & b \\ c & d\end{matrix} ] x + [ \begin{matrix}e \\ f\end{matrix} ] \qquad ( 8 )$$

where a to f form a set of 6 parameters that define the transform.

The projective transform can be written in a linear matrix form using homogeneous coordinates. The point correspondence between two homogeneous coordinates z=[x, y, 1]^{T} and z′=[x′, y′, 1]^{T} can be written as

wz′=Hₘz (9)

where w is an arbitrary scaling and the projective transformation matrix Hₘ is a 3×3 matrix with 8 free parameters given by

$${H}_{m} = [ \begin{matrix}{h}_{11} & {h}_{12} & {h}_{13} \\ {h}_{21} & {h}_{22} & {h}_{23} \\ {h}_{31} & {h}_{32} & 1\end{matrix} ] \qquad ( 10 )$$

where h₁₁ . . . h₂₃ are affine transform parameters and h₃₁and h₃₂ are projective distortion parameters. The same projective transform is given for any scalar multiple of this matrix.

A cubic transform is a nonlinear transform that takes the form:

$$[ \begin{matrix}{x}^{′} \\ {y}^{′}\end{matrix} ] = [ \begin{matrix}P & 0 \\ 0 & P\end{matrix} ] [ \begin{matrix}{c}_{0} \\ ⋮ \\ {c}_{19}\end{matrix} ] , \qquad ( 11 )$$

where the 20 parameters cᵢ define the transform and the diagonal terms are defined in terms of polynomial expressions of the coordinates in the first image:

P=[x³, x²y, x y², y³, x², x y, y², x, y, 1]. (12)

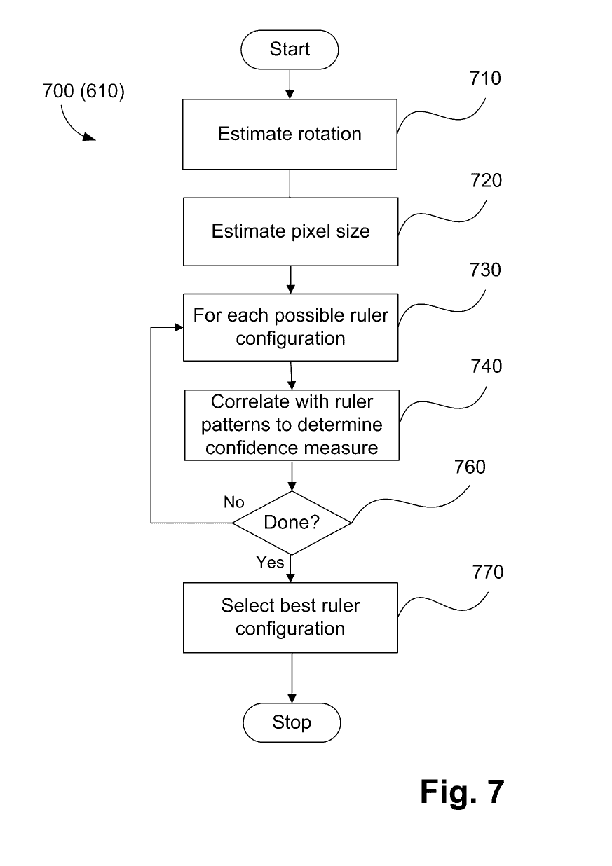

Step 610 is an optional processing step to determine a coarse alignment of the image to the calibration target. This coarse alignment may take the form of determining the coarse rotation and approximate resolution of the pixels in the image, in addition to information such as the orientation of placement of the calibration target with respect to the microscope field of view. Step 610 may additionally supply a higher order transform such as a perspective or affine distortion. If step 610 is not performed then it is assumed that coarse alignment of the calibration target is known and supplied to method 600, for example as a pixel resolution and an assumed rotation of zero. A suitable method of coarse alignment that may be used at step 610 is described in method 700 below with reference to FIG. 7.

Step 620 selects a transverse alignment grid for the analysis of the captured pixel image. Alignment is performed based on the analysis of small patches around the centre of the alignment grid points. Square patches are suitable for this analysis, the patches being at least as large as the expected size of the periodic patterns used to define the calibration target discussed above with respect to FIG. 3. A buffer region is defined around the outside of the image. Desirably the buffer region given by the half of the expected size of the bounding box in image space that contains the largest periodic pattern transformed to the image space according to the coarse alignment. A rectangular grid of evenly spaced grid points extending to the edge of this buffer region is suitable for transverse warp map generation.

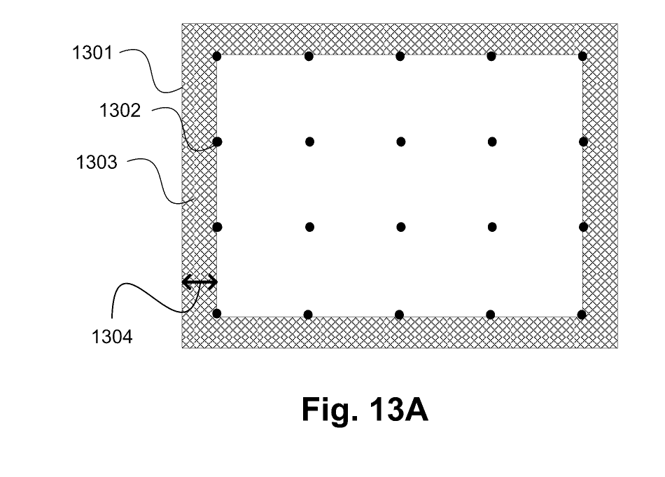

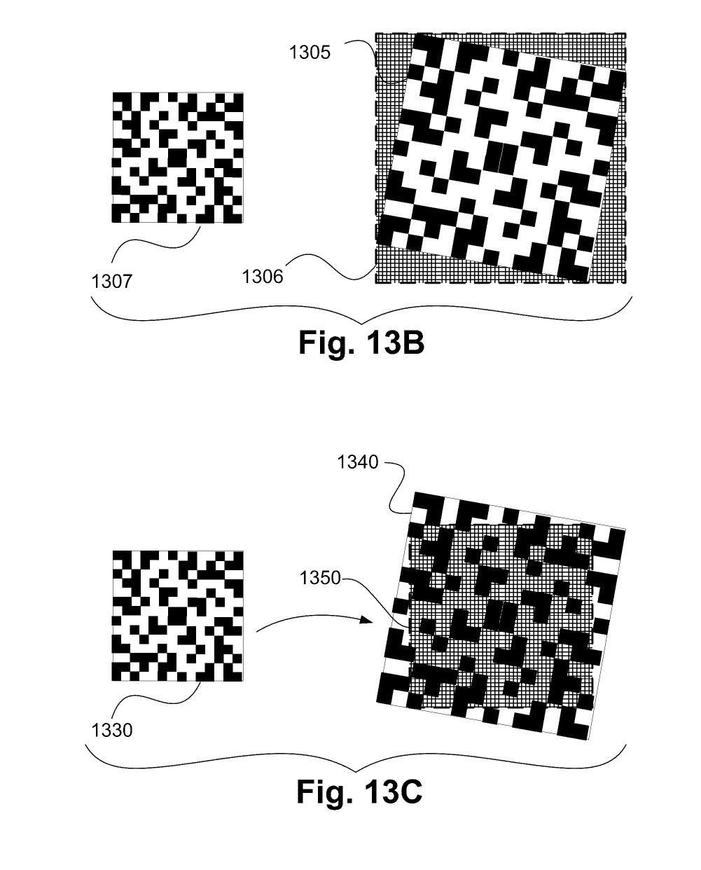

FIG. 13A illustrates the transverse alignment grid locations over an image region for which the buffer region 1303 extends inwardly a fixed distance 1304 from the outside of the image 1301. A 5 by 4 grid of dots including dot 1302 define the alignment grid locations. FIG. 13B illustrates the determination of the size of the buffer region 1303. A pattern 1307 is the largest of the periodic patterns that was used to define the test pattern 305 on the calibration target 102. The pattern maps 1307 to region 1305 when mapped to image space according to the coarse rotation (taken as zero if no coarse rotation information is available), the coarse scaling information and the feature size of the calibration target. A bounding box 1306 is a bounding box that contains the pattern 1305 (the grid fill illustrating the pixel size in the image space). The width, w, of the buffer region can be calculated as follows:

$$w = ceil ( \frac{{N}_{max} {L}_{feat} ( \vert cos θ \vert + \vert sin θ \vert )}{{L}_{pix}} ) \qquad ( 13 )$$

where Nₘₐₓ is the largest period, L_{feat} is the feature size of the calibration target, Lₚᵢₓ is the approximate pixel resolution, and θ is the coarse rotation of the calibration target. For example if the expected scaling is 0.5 microns per pixel, the feature size is 2 microns, the largest period is 51, and there is no rotation, the buffer region would be 102 pixels. With a rotation of 5°, the bounding box would increase to 111 pixels.

The total number of grid points should be at least as large as the number of free parameters, and can be much larger allowing the effective use of robustification methods, such as RANSAC, to improve the reliability of the calculated transform. The affine, cubic and projective transforms described above have 6, 8 and 20 parameters respectively. Depending on the robustness of the estimation of transverse locations on the calibration target 102 at the grid locations, as generated at step 650, a suitable number of grid locations might be 6 by 6.

After setting the transverse alignment grid at step 620, a loop structure starting at step 630 is employed to measure the positions on the calibration target of the each point on the alignment grid in turn. First, at step 635 a coarse aligned image patch is created centred at the alignment grid location. The image patch is transformed to take into account the coarse rotation (θ) of the calibration target image and the scaling due to the combination of the target feature size and pixel resolution (L_{feat} and Lₚᵢₓ). A high order interpolation scheme is suitable for this transform, such as a cubic or sinc interpolation, and this may be performed in Fourier space.

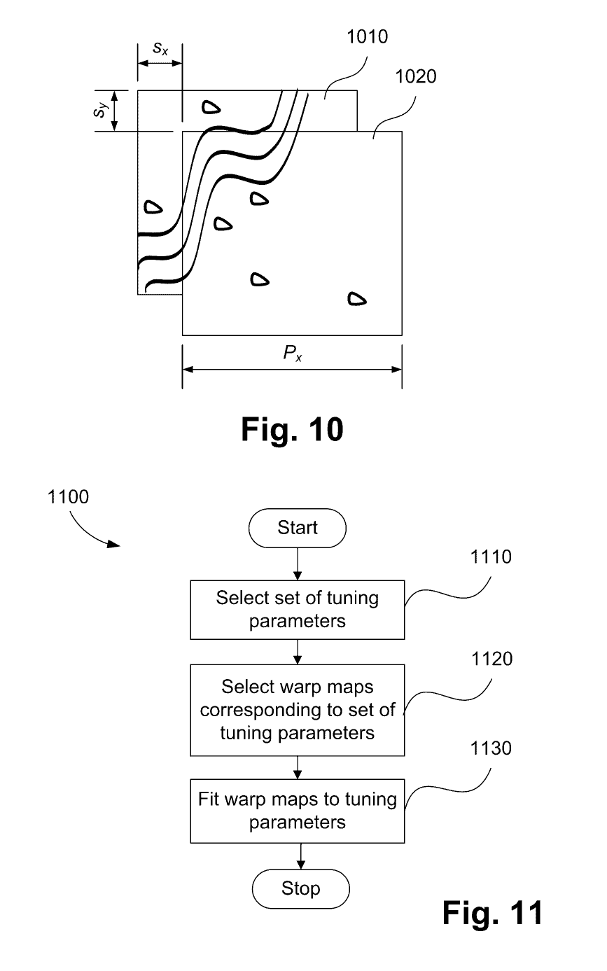

Next, at step 640, the vector offsets of the periodic patterns of the specific test pattern 305 of the calibration target 102 at the grid point are determined by a shift estimation method such as a correlation-based or gradient-based method. In this regard, any test pattern, such as the test pattern 305 of FIG. 3E, may be stored in the storage 106 (HDD 1510) for subsequent use in processing and comparison as required. The shift estimation method may also return a confidence value corresponding how similar the compared image patches are. The periodic patterns were illustrated in FIGS. 3A to 3D and discussed above. Shift estimation is described with reference to FIG. 10 which shows two patches 1010 and 1020 from different images. The shift is the vector s=[sₓ, s_{y}]^{T} of the amount in the horizontal and vertical axes that the patch 1020 from image 2 must be offset from the patch 1010 from image 1 to make the area where the patches overlap the most similar. In this case, periodic boundary conditions are used as the patterns are periodic by design, and no padding or window function is applied. Each of the periodic patterns (e.g. 301, 302, 303 and 304) used in the test pattern 305, each of which for example is stored in the memory 106, is compared with an image patch of the same size taken from the centre of the coarse aligned patch from step 635, and a vector offset, sᵢ(sₓ,s_{y}), is estimated.

The vector offsets generated at step 640 are then analysed at step 650 to determine a transverse location on the ruler. Given the periodic nature of the test pattern 305 used to construct the calibration target 102, the i^{th} shift estimate can be interpreted as an estimate of the true position of the grid point x′=(x′,y′)^{T} modulo the i^{th} pattern period, pⁱ:

sₓⁱ=mod(x′, pⁱ), s_{y}ⁱ=mod(y′, pⁱ). (14)

The coordinates x and y may be considered separately in the first part of the analysis.

The x component of the i^{th} shift estimate can be used to select a finite set of possible x-locations within the known physical extent of the target. Considering the set of possible locations associated with a set of shift estimates together, and assuming the shift estimates are sufficiently accurate, the distribution of the possible locations from the different patterns will cluster together very tightly around the true location of the grid point. If the product of the set of periods considered together is large enough then this will occur at a single point within the region covered by the calibration target and a position estimate may be formed based on the cluster of points (e.g. using the average or median).

A location estimate may be formed using a subset of the periodic patterns of the ruler. For the case of a calibration target 102 designed based on 4 periodic patterns, such as that shown in FIGS. 3A to3E, it is possible to form four different position estimates based on three of the patterns. The best of these estimates may be selected by comparing the known test pattern 305 of the 2D ruler at each estimated location to the coarse aligned patches from step 635. One method of selecting the best location estimate is to perform a correlation shift estimation between the test pattern 305 at the estimated location and the image patch. In this case, periodic boundary conditions are not used, and it is appropriate to use padding and a window function such as the Tukey window function:

$$w ( i , j ) = \frac{1}{4} [ 1 + cos ( α π \frac{2 ( i - W / 2 )}{( W - 1 )} ) ] [ 1 + cos ( απ \frac{2 ( j - H / 2 )}{( H - 1 )} ) ] \qquad ( 15 )$$

where w is the weighting of the pixel at coordinate (i,j), W is the patch width and H is the patch height, and α is a fractional parameter defining the spread of the window function, for which a suitable parameter setting is 0.5. The correlation will provide a correction to the position of the grid location, and also a confidence score which may be used to select the best position estimate.

Once a vector position has been generated at step 650, step 660 checks if there are more transverse alignment grid locations to process, in which case processing returns to step 630, otherwise processing continues to step 670.

Step 670 forms a transverse warp map for the image based on the corresponding pairs of estimated locations in calibration space (x′) and transverse alignment grid points in sensor pixel space (x). The transverse warp map may be an affine, projective, cubic or other transform as described above. Methods of estimating the coefficients of affine, projective and various suitable nonlinear transforms based on sets of point pairs in the two spaces are well known. For example, the coefficients of the cubic transform may be solved by setting up the cubic transform matrix of Equation (11) as a set of linear equations in the coefficients P for the set of corresponding point pairs and finding the least squares solution for the coefficients. Methods of improving the robustness of the estimates are also well known, for example the RANSAC method may be used to find fits to subsets of the point pairs and then compare inliers and outliers of the fits, thereby arriving at a robust, accurate fit. Forming a transverse warp map at step 670 completes the processing of step 600.

FIG. 7 is a schematic flow diagram that illustrates a method 700 of coarse alignment for a calibration target 102 that may be used at step 610. Again the method 700 may be implemented using software stored on the HDD 1510 and executed by the process 1505. Method 700 starts at step 710 which estimates the rotation of the calibration target 102 relative to the pixels of a captured image of the calibration target 102 taken using a microscope 101. First, a large square patch of the captured image is selected. This patch should be sufficiently large to preferably include a number of periods of each of the periodic patterns 301-304. A window function is applied to the selected patch, such as the Tukey window defined above, and then a Fourier transform is taken. A low pass filter is applied to remove parts of the spectrum associated with frequencies below the expected periodicity of the patterns in the 2D ruler (which may be estimated using an approximate pixel scaling based on the approximate known configuration of the microscope 101). Next, the modulus of the complex Fourier coefficients is taken and a radon transform is applied to convert to angular and distance coordinates, where a suitable resolution for the transform is 1000 in the angular and 400 in the distance coordinate. The radon transformed coefficients (R) are summed over the distance coordinate to give a one dimensional array of values corresponding to the power in the spectrum of the original image with angle over an angular range of π radians. Given that the patterns are periodic in x and y, it will only be possible to determine a rotation estimate within a single quadrant of the unit circle, and so the first half of the array can be added to the second half of the array to give a power spectrum corresponding to the angular range 0 to π/2 radians. The estimated rotation of the calibration target 102 is selected as the angle corresponding to the peak in this power spectrum.

Following the coarse rotation estimation at step 710, a coarse pixel scale estimation is performed at step 720 to estimate pixel size. This is achieved by processing the radon transformed coefficients (R) of step 710 at the index associated with the angular peak in the power spectrum detected at step 710. This sampled data has a periodicity associated with the average periodicity of the periodic patterns in the test pattern 305 along the direction of the distance coordinate of the radon transform. This sampled data may be Fourier transformed to determine the periodicity of the signal. Next, if the sizes of the periodic patterns are sufficiently close, then this measured signal periodicity can be compared to the average periodicity of the periodic patterns at the angle associated with the peak index to determine a coarse scaling estimate.

Following the coarse scaling estimation performed at step 720, a loop structure is employed starting at step 730 to determine the best configuration of the 2D ruler of the calibration target 102. In general, the exact details of the ruler being imaged should be known (i.e. from the test pattern 305), and the ruler should be placed facing up. However in some cases it may be useful for the processor 1505 to determine whether the ruler is facing up or down, or to select which ruler from a library of known rulers (i.e. multiple test patterns 305) has been imaged. If it is assumed that the ruler details are exactly known, and the ruler has been correctly placed face up, then there are four possible configurations at rotations of 90 degrees relative to each other. The periodic patterns for the each configuration are formed by rotating and or reflecting the test patterns according to the configuration.

At step 740, the next possible ruler configuration is checked by performing the offsets of the periodic patterns for the current configuration and the correlation strengths associated with them using the method described at step 640. Step 760 checks there are more configurations to check, and if there are then processing returns to step 730. If there are no further configurations to check then processing continues to step 770 which selects the best ruler configuration as the configuration for which the sum of the confidence score for the set of periodic patterns of the ruler is highest, ending method 700.

For an optical system with small non-linear distortions, it is generally sufficient to perform a single coarse alignment step. However in the case of a large capture region and/or large optical distortions, such as a projective or barrel distortion, it may be appropriate to perform coarse alignment a multiple locations over the field of view and to define the coarse alignment based on a larger set of coefficients than simply the rotation and scaling described above.

FIG. 8 is a schematic flow diagram that illustrates a method 800 of analysing an captured image of a calibration target 102 to generate normalised contrast data or metrics based on the analysis of patches of the captured image. This method may be used at steps 430 and 520.

Method 800 starts at step 810 which selects a depth estimation grid. The contrast metric will be calculated based on the analysis of small patches selected around the centre of points forming the depth estimation grid in the captured image. Square patches are suitable for this analysis, and a suitable patch size, referred to as the contrast metric patch size, may be 100 pixels. If a buffer region is defined around the outside of the captured image, given by the half of the contrast patch size, then a rectangular grid of evenly spaced grid points extending to the edge of this buffer region is suitable for transverse warp map generation. A suitable number of points depends on the size of the image capture region and the flatness of the focal plane of the microscope, and may be around 6 by 6. This is discussed later with reference to FIG. 13A.

Next, at optional step 820, a radiometric correction may be made to the captured image data to correct for uneven illumination across the field of view, for example due to vignetting. Methods of radiometric correction are known.

Continuing to step 825, a loop structure is used to process each of the points in the depth estimation grid selected at step 810. First, at step 830, an image contrast metric is calculated at the current grid point. A patch of the captured image with the contrast metric patch size is selected and a window function, such as the Tukey window defined above, is applied. Next, the contrast metric is calculated for the windowed patch from the captured image. Many focus functions described in the literature are suitable for this step, including the normalised variance. The normalised variance is defined as follows:

$${F}_{NV} = \frac{1}{HW μ} {\sum }_{i = 0}^{W - 1} {\sum }_{j = 0}^{H - 1} {( {I}_{i , j} - μ )}^{2} \qquad ( 16 )$$

where I_{i,j} is the intensity of the pixel at location (i,j) in the patch, W and H are the width and height of the patch, and p, is the mean intensity over the patch.

Following the computation of the contrast metric at the current grid location, a normalisation is computed at step 840. The normalisation may be considered a reference contrast metric and is determined using the test pattern 305. First, the position of the current grid location in the captured image is transformed to the space of the test pattern 305 according to the known transverse warp map for the captured image that was estimated earlier in the processing flow according to step 670. Next, a region around the transformed position in the test pattern 305 is selected, either from the stored representation of the test pattern 305, or constructed according to the known periodic patterns (e.g. 301-304) form which the test pattern 305 was formed. The size of the region is selected so that, when the region is transformed into image space (i.e. the space of the selected patch in the captured image) according to the known transverse warp map, the region covers an area at least as large as the contrast metric patch size used at step 830. This is illustrated in FIG. 13C where a suitably sized region 1330 in the space of the test pattern 305 (calibration target 102) is transformed to fit within a patch 1340 in the captured image space. Here, a hatched region 1350 represents the required patch size in captured image space (the contrast metric patch size) which is contained within the region 1340.

The region (e.g. 1330) derived from the test pattern 305 is then transformed to image space according to the transverse warp map. A high order interpolation method is suitable for this transformation. Also, given that the calibration target 102 should consist of square regions it is appropriate to first upscale the test pattern region 1330 using a morphological operation to create a high resolution representation consisting of flat regions (e.g. zero where the target blocks the transmission of light, and 1 where the target transmits the light). This high resolution representation of the test pattern 305 is then interpolated to generate the image space region according to a modified transverse warp map which is downscaled relative to the transverse warp map according to the morphological upscaling described above. A region 1350 of the transformed calibration target 1340 is selected centred according to the original transverse alignment grid point and with the contrast metric patch size of the captured image. A contrast metric is calculated for this region according to the same method used at step 830 and this value defines the normalisation, being the reference contrast metric

The normalised contrast metric is then calculated at step 850 by dividing the image contrast metric calculated at step 830 by the normalisation (the reference contrast metric) determined at step 840. The normalised contrast metric has the property of compensating for an effect of local non-uniform texture of the test pattern data, as mentioned above. Following this, step 860 checks if there are more transverse alignment grid locations to process, in which case processing returns to step 825, otherwise method 800 ends.

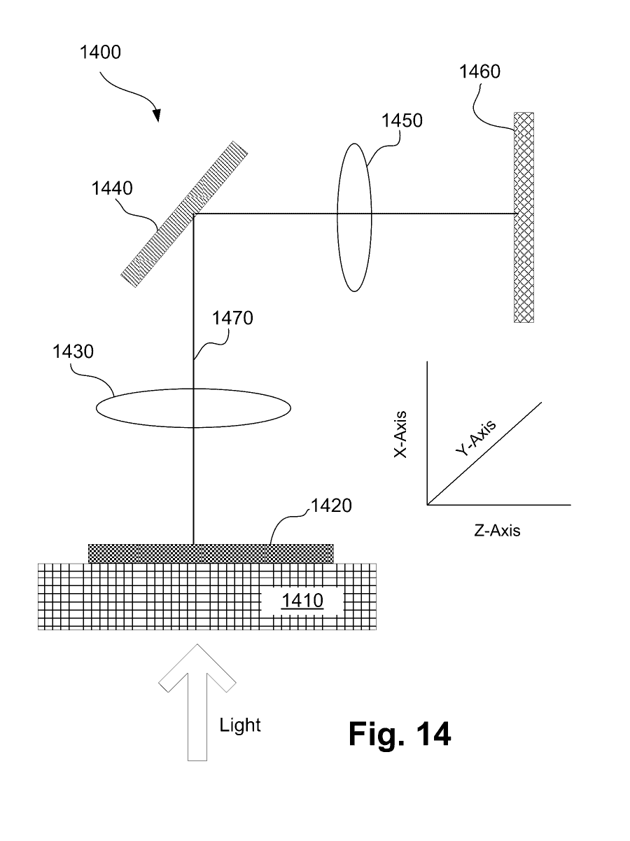

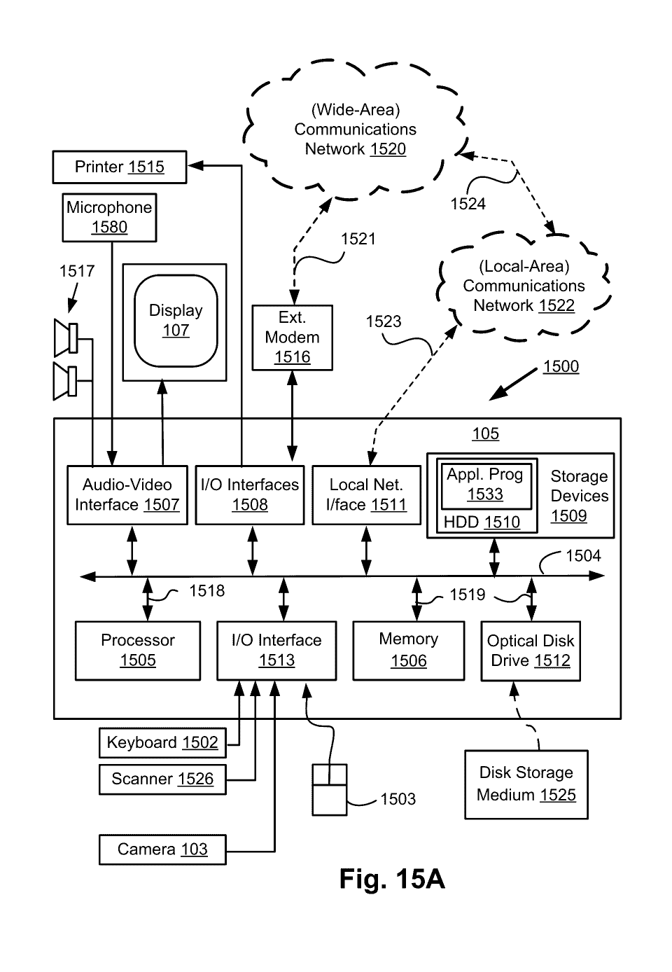

FIG. 11 is a schematic flow diagram that illustrates a (first) method 1100 of determining calibration parameters for a microscope that may be used at step 260 of method 200. Method 1100 is suitable for a microscope 1400 arranged according to the diagram in FIG. 14. The microscope 1400 as schematically illustrated includes a stage 1410, on which a calibration target 1420 is placed. Light is transmitted through the stage 1410 and the target 1420, then through an optical system formed of one or more lenses (1430 and 1450), reflected from a mirror 1440, and focused onto the sensor 1460. An illustrative light path 1470 through the centre of the lenses 1430, 1450 is shown. In this arrangement, the sensor 1460 may be translated in the z-axis and rotated around the x-axis, while the mirror 1440 may be tilted around the y-axis. These three configuration properties are selected as tuning parameters at step 1110 in an initial step of the method 1100. Alternative microscope arrangements with different sets of configuration properties may be calibrated using similar techniques to those described herein.

After the selection of the tuning parameters at step 1110, step 1120 selects warp maps generated for a set of calibration images corresponding to the tuning parameters. For example, if each of the tuning parameters may be varied over a known range of values, then a suitable set of images would correspond to a uniform sampling of the space defined by the tuning parameters. For example, each of the three tuning parameters described above may be sampled at 5 discrete values, and the complete set of images would be based on (5×5×5)=125 images that includes all combinations of these tuning parameters on a 3D grid.

Next, at step 1130, the warp maps are fitted to the tuning parameters. The simplest method of fitting is to create a 3D interpolation function for each parameter of each warp map based on the sampling of parameters at the discrete set of tuning parameters corresponding to the set of images. The value at each parameter at any intermediate location may be found based on the interpolation, and therefore the warp map at may be determined. A linear interpolation may be used for this purpose.

Alternatively, at step 1130, a linear depth warp map for the i^{th} image can be expressed as:

zᵢ(x, y)=z₀ⁱ+xzₓⁱ+yz_{y}ⁱ (17)

This fit can be modelled as a linear function of the sensor translation, sensor rotation and mirror rotation, which for the i^{th} image will be expressed as Δzⁱ, θₓⁱ, and θ_{y}ⁱ. The linear fit is:

zᵢ=C Θᵢ+εᵢ, (18)

where zᵢ=(z₀ⁱ, zₓⁱ, z_{y}ⁱ)^{T}, Θᵢ=(1, Δzⁱ, θₓⁱ, θ_{y}ⁱ)^{T}, and C is a 3 by 4 matrix of linear coefficients. Due to various sources of noise in the system, the above equation include a residual error term, εᵢ. Equation (18) can be re-written as:

zᵢ=Hᵢ C_{f}+εᵢ (19)

where C_{f} is a flattened vector of the coefficients of the matrix C:

C_{f}=(C₀₀, C₀₁, C₀₂, C₀₃, C₁₀, C₁₁, C₁₂, C₁₃, C₂₀, C₂₁, C₂₂, C₂₃)^{T} (20)

and:

$${H}_{i} = ( \begin{matrix}{Θ}_{i}^{T} & 0 & 0 \\ 0 & {Θ}_{i}^{T} & 0 \\ 0 & 0 & {Θ}_{i}^{T}\end{matrix} ) \qquad ( 21 )$$

For a set images corresponding to configurations (Δzⁱ, θₓⁱ, θ_{y}ⁱ) with linear fit coefficients (z₀ⁱ, zₓⁱ, z_{y}ⁱ) a linear set of equations can be constructed by including an equation of the form of Equation (19) for each image. This gives the following equation:

$$( \begin{matrix}{z}_{0} \\ ⋮ \\ {z}_{N}\end{matrix} ) = ( \begin{matrix}{H}_{0} \\ ⋮ \\ {H}_{N}\end{matrix} ) {C}_{f} + ( \begin{matrix}{ε}_{0} \\ ⋮ \\ {ε}_{N}\end{matrix} ) \qquad ( 22 )$$

The coefficients of the calibration matrix C_{f} can be determined in the least squares sense by solving Equation (22) using standard methods. The advantage of this fit is that it is relatively straightforward to invert in order to determine the set of tuning parameters that corresponds to a desired warp map, for example in the case that the microscope 1400 is required to follow a surface with defined properties.

Once the fitting of warp maps to tuning parameters has been completed, the processing of method 1100 ends. The result of the method 1100 is, by fitting the selected warp maps to the set of tuning parameters, complementary tuning parameters are determined that provide for adjustment of the microscope 101 to permit the tuning-out of warp from images to be thereafter captured, thus affording improved imaging using the microscope 101.

If method 1100 is applied at step 260 of method 200, then the optional step 270 would store the various interpolation functions and coefficients determined at step 1130 in the HDD 1510, and step 280 may be adapted to set the tuning parameters in order to track a specified surface. The transverse warp map then might supply useful information for processing the images, for example to generate a whole slide image of a specimen.

FIG. 12 is a schematic flow diagram that illustrates an alternative (second) method 1200 of determining calibration parameters for a microscope that may be used at step 260 of method 200. Method 1200 is also suitable for a microscope arranged according to the diagram in FIG. 14, however, the microscope may include multiple optical paths 1470 from the target 1420 to a set of sensors 1460. Each path includes a corresponding sensor 1460 and mirror 1440, and so the set of tuning parameters include a translation along the z-axis and rotation around the x-axis for each sensor, and a mirror rotation around the y-axis for each mirror (i.e. a total of 3 tuning parameters per optical path).

Method 1200 starts at step 1210 which employs a loop structure to process the warp map data associated with each sensor in turn. The method 1200 continues to step 1220 which employs a second loop structure to process the warp map data for the current sensor and for each environmental condition in turn. An example of an environmental condition may be the temperature.

Next, at step 1230, the set of tuning parameters are selected, which are the set of parameters associated with the current sensor. Following this, step 1240 selects warp maps for a set of calibration images corresponding to the tuning parameters at the current environmental condition. As discussed with relation to step 1120 above, if each of the tuning parameters may be varied over a known range of values, then a suitable set of images would correspond to a uniform sampling of the space defined by the tuning parameters. For example, each of the three tuning parameters described above may be sampled at 5 discrete values, and the complete set of images would be based on (5×5×5)=125 images that includes all combinations of these tuning parameters on a 3D grid.

Step 1250 then fits the selected warp maps to the tuning parameters according to the same method described at step 1130 above. Processing then continues to step 1260 which checks if there are further environmental conditions to consider, in which case processing returns to step 1220, otherwise processing continues to step 1270. Step 1270 fits the sets of interpolation functions and coefficients determined at step 1250 to the environmental condition data. This may be achieved using an interpolation method, such as linear interpolation. Processing then continues to step 1260 which checks if there are further sensors to consider, in which case processing returns to step 1210, otherwise the method 1200 ends.

If the method 1200 is applied at step 260 of method 200, then the optional step 270 would operate to store the various interpolation functions and coefficients determined at step 1270, and step 280 may be used to set the tuning parameters in order ensure that the set of sensors are configured to be as close as possible to co-planar over a range of environmental conditions, or to actively configure the set of sensors to match a specified surface profile.

The arrangements presently described offer a number of advantages over comparable existing approaches, for example a combination of standard focus finding for 2D ruler target with transverse position estimation. The advantages include:
(i) whereas existing techniques obtain either 2D location or depth, the present arrangements determine depth with a 2D location, thereby extending an existing 2D ruler use to a 3D case;
(ii) fewer images are used for 3D position estimation in that the present arrangements use 2 images whereas prior art approaches require at least one image for each unknown in depth fit (minimum of 3 parameters, or 5 for the modified Gaussian fit) and work best with at least one extra image;
(iii) the present arrangements have fewer constraints on depth of test images relative to best focus. For example the present arrangements can work with pair of images on same side of best focus, and can perform out to relatively large distances. By contrast, existing approaches require images on both sides of best focus, such that if the focal plane changes across the field of view (tilted microscope components) up to 10 microns of depth variation may result;
(iv) transverse accuracy of the present arrangements is same as existing approaches; and
(v) depth accuracy of the present arrangements is generally comparable to that of existing arrangements and whilst in some applications the depth accuracy of existing approaches is better than the present arrangements, such accuracy is only achieved through more constrained operation (small tilts, closer space capture image).

### INDUSTRIAL APPLICABILITY

The arrangements described are applicable to the computer and data processing industries and particularly for the viewing of microscopic images, such as with 3D virtual microscopy.

The foregoing describes only some embodiments of the present invention, and modifications and/or changes can be made thereto without departing from the scope and spirit of the invention, the embodiments being illustrative and not restrictive.

(Australia Only) In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method of calibrating a microscope using a test pattern, said method including the steps of:
(a) capturing a plurality of images of the test pattern through an optical system of the microscope, said test pattern having a plurality of uniquely identifiable positions across the pattern defined by a plurality of repeating and overlapping 2D sub-patterns;
(b) for each of a plurality of corresponding positions on at least two of the captured images:
selecting a patch in the captured image at a position selected from the plurality of uniquely identifiable positions on the test pattern and a corresponding region in the test pattern whereby a location for the corresponding region is determined by the plurality of repeating and overlapping 2D sub-patterns in the test pattern;
determining an image contrast metric from the captured image of the test pattern in the selected patch and a reference contrast metric of the test pattern in the corresponding region; and
determining a normalised contrast metric using the reference contrast metric and the image contrast metric, said normalised contrast metric compensating for an effect of local non-uniform texture of the test pattern;
(c) estimating depths of the at least two captured images at the plurality of positions using the normalised contrast metrics and a set of predetermined calibration data for a stack of images captured using the test pattern at a range of depths; and
(d) calibrating the microscope using a comparison of the determined depth estimates for the at least two captured images.

2. A method according to claim 1 wherein the plurality of images are captured as pairs of images in which an axial offset is imparted to a stage of the microscope between the captures.

3. A method according to claim 2 wherein step (c) comprises estimating a plurality of depths for each position of each image of the pair based on the normalised contrast metrics of the pair of images, and resolving the depths into a single estimate of depth for each of the positions.

4. A method according to claim 1 wherein the depth estimates for each of the plurality of positions of at least one of the captured images form a warp map for that image.

5. A method according to claim 1 further comprising:
capturing the stack of images of the test pattern at least spanning depths above and below a depth of best focus of the microscope;
generating the predetermined calibration data for each of the plurality of positions on each of the captured stack images by:
(i) forming a transverse warp map for each stack image;
(ii) forming normalised contrast data from the transverse warp map; and
(iii) analysing the normalised contrast data to form the predetermined calibration data.

6. A method according to claim 5 wherein the forming of the normalised contrast data comprises:
selecting a patch in the captured stack image of the test pattern at a position selected from the plurality of uniquely identifiable positions on the test pattern and a corresponding region in the test pattern whereby a location for the corresponding region is determined by the plurality of repeating and overlapping 2D sub-patterns in the test pattern;
determining an image contrast metric from the captured stack image in the selected patch and a reference contrast metric of the test pattern in the corresponding region; and
determining a normalised contrast metric based on the reference contrast metric and the image contrast metric, said normalised contrast metric compensating for an effect of local non-uniform texture of the test pattern.

7. A method according to claim 1, wherein multiple determined depth offsets across different positions on the captured image plane define a warp map between 2D positions of a sensor of the microscope and 3D positions in the focal plane of the microscope with reference to the test pattern.

8. A method according to claim 1, wherein step (c) comprises comparing at least an estimated pair of depths with a depth offset known from the predetermined calibration data to determine a single depth estimate for current position.

9. A method according to claim 8 further comprising adjusting a configuration of the microscope between capture of the images.

10. A microscope calibrated according to the method of claim 1.

11. A non-transitory computer readable storage medium having a program recorded thereon, the program being executable by computer apparatus to calibrate a microscope using a test pattern, said program comprising:
code for capturing a plurality of images of the test pattern through an optical system of the microscope, said test pattern having a plurality of uniquely identifiable positions across the pattern defined by a plurality of repeating and overlapping 2D sub-patterns;
code, executable for each of a plurality of corresponding positions on at least two of the captured images, to:
select a patch in the captured image at a position selected from the plurality of uniquely identifiable positions on the test pattern and a corresponding region in the test pattern whereby a location for the corresponding region is determined by the plurality of repeating and overlapping 2D sub-patterns in the test pattern;
determine an image contrast metric from the captured image of the test pattern in the selected patch and a reference contrast metric of the test pattern in the corresponding region; and
determine a normalised contrast metric using the reference contrast metric and the image contrast metric, said normalised contrast metric compensating for an effect of local non-uniform texture of the test pattern;
code for estimating depths of the at least two captured images at the plurality of positions using the normalised contrast metrics and a set of predetermined calibration data for a stack of images captured using the test pattern at a range of depths; and
code for calibrating the microscope using a comparison of the determined depth estimates for the at least two captured images.

12. A computer readable storage medium according to claim 11 wherein the plurality of images are captured as pairs of images in which an axial offset is imparted to a stage of the microscope between the captures.

13. A computer readable storage medium according to claim 12 wherein the code for estimating comprises code for estimating a plurality of depths for each position of each image of the pair based on the normalised contrast metrics of the pair of images, and resolving the depths into a single estimate of depth for each of the positions.

14. A computer readable storage medium according to claim 11 further comprising:
code for capturing the stack of images of the test pattern at least spanning depths above and below a depth of best focus of the microscope;
code for generating the predetermined calibration data for each of the plurality of positions on each of the captured stack images by:
(i) forming a transverse warp map for each stack image;
(ii) forming normalised contrast data from the transverse warp map; and
(iii) analysing the normalised contrast data to form the predetermined calibration data.

15. A computer readable storage medium according to claim 14 wherein the code for forming of the normalised contrast data comprises:
code for selecting a patch in the captured stack image of the test pattern at a position selected from the plurality of uniquely identifiable positions on the test pattern and a corresponding region in the test pattern whereby a location for the corresponding region is determined by the plurality of repeating and overlapping 2D sub-patterns in the test pattern;
code for determining an image contrast metric from the captured stack image in the selected patch and a reference contrast metric of the test pattern in the corresponding region; and
code for determining a normalised contrast metric based on the reference contrast metric and the image contrast metric, said normalised contrast metric compensating for an effect of local non-uniform texture of the test pattern.

16. A microscope calibration system comprising:
a microscope having a movable stage and a sensor for capturing images of a test pattern mounted to the stage;
a computer processor arrangement coupled to the stage and the sensor and operable to:
cause capture a plurality of images of the test pattern through an optical system of the microscope, said test pattern having a plurality of uniquely identifiable positions across the pattern defined by a plurality of repeating and overlapping 2D sub-patterns;
for each of a plurality of corresponding positions on at least two of the captured images, to:
select a patch in the captured image at a position selected from the plurality of uniquely identifiable positions on the test pattern and a corresponding region in the test pattern whereby a location for the corresponding region is determined by the plurality of repeating and overlapping 2D sub-patterns in the test pattern;
determine an image contrast metric from the captured image of the test pattern in the selected patch and a reference contrast metric of the test pattern in the corresponding region; and
determine a normalised contrast metric using the reference contrast metric and the image contrast metric, said normalised contrast metric compensating for an effect of local non-uniform texture of the test pattern;
estimate depths of the at least two captured images at the plurality of positions using the normalised contrast metrics and a set of predetermined calibration data for a stack of images captured using the test pattern at a range of depths; and
calibrate the microscope using a comparison of the determined depth estimates for the at least two captured images.

17. A microscope calibration system according to claim 16 wherein the calibration comprises adjusting a position of the stage according to the comparison.
